(19) United States
(12) Patent Application Publication
(10) Pub. No.: US 2006/0127746 A1
(43) Pub. Date: Jun. 15, 2006

(54) Electode-supported fuel cell

(76) Inventors: Gijsbertus Rietveld, Alkmaar (NL); Gerry Martina Regina Van Druten, Leiden (NL)

Correspondence Address: YOUNG & THOMPSON, 745 SOUTH 23RD STREET, 2ND FLOOR, ARLINGTON, VA, 22202, US

(21) Appl. No.: 10/529,486

(22) PCT Filed: Sep. 29, 2003
(86) PCT No.: PCT/NL03/00663

§ 371 Date: Jan. 13, 2006

(30) Foreign Application Priority Data
Sep. 27, 2002 (NL) 1021547

(51) Int. Cl. H01M 4/86; H01M 4/90; B05D 5/12; H01M 4/88

(52) U.S. Cl. 429/44; 429/45; 502/101; 427/115; 427/126.6

(57) ABSTRACT

Cathode-supported fuel cell wherein the cathode support comprises a porous part made of an alloy containing iron and chromium and more particularly stainless steel. The anode has a thickness of 1-50 μm and preferably consists of nickel/nickel oxide. The cathode preferably consists of LSM material. Such an electrode-supported fuel cell can be produced by providing a metallic support containing at least iron or chromium by means of sintering, preferably starting form a powder, successively applying thereto an electrode, electrolyte and other electrodes. With this method a cathode is applied to the metallic support and the combination obtained is sintered at a temperature between 1000 and 1200° C.

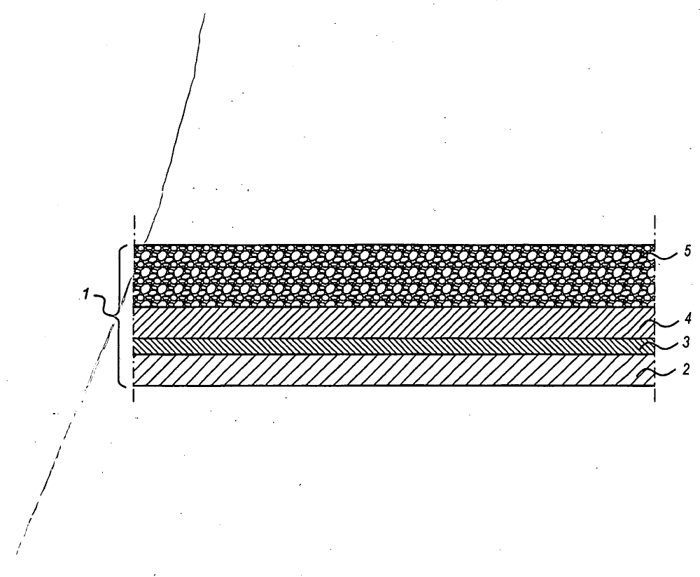

The present invention relates to a fuel cell supported on the electrode side, comprising an anode, electrolyte and cathode, the electrode support comprising a porous part made of an alloy with iron and chromium. Such a fuel cell is disclosed in Fuel Cells Bulletin No. 21, page 7, Schiller et al. “Development of vacuum plasma sprayed thin-film SOFC for reduced operating temperature”. In this publication an anode-supported fuel cell is described where the anode support consists of an iron and chromium material, such as stainless steel or chromium-based alloys such as are obtainable from Plansee in Austria.

An electrochemical cell of this type is in particular a solid oxygen fuel cell (SOFC). With the aid of plasma spraying techniques an anode layer is applied to a metallic support, followed by electrolyte and cathode.

It has been found that such a fuel cell is not entirely satisfactory. The conditions which the steel anode support on the anode side must be able to withstand are very diverse. It must be a heat-resistant steel under reducing conditions, with different oxygen partial pressure at anode inlet and outlet and presence of water in the feed or as reaction product. In addition, for example in the case of the anode fuel supply failing, the oxygen partial pressure will change substantially within a short time. All of this occurs at a high (operating) temperature. Consequently, the demands imposed with regard to oxidation at the support used differ from those imposed for types of steel in a “normal” environment of air.

Moreover, the use of a porous support provided on the anode side gives rise to the risk of gas distribution limitations. This reduces the performance of the cell. After all, if the reactants are not adequately removed and the reaction products are not adequately supplied from/to the active anode surface, the fuel utilisation at the anode will appear to be higher than it actually is. This has two adverse effects. Firstly, as a result of the lower fuel pressure at the anode surface the rate of reaction of the fuel will be adversely affected. Secondly, the high oxygen potential above the anode can produce oxidation and degradation of the anode material. If, as a result of oxidation, the pores of the steel support slowly close up with metal oxide, the gas distribution problems can also arise during operation of the cell.

When various metal alloys are used there is a risk that, in the presence of (traces of) nickel therein, carbon is formed when methane is used as anode gas.

The aim of the present invention is to provide a fuel cell that can be produced inexpensively and does not have the disadvantages described above. This aim is realised with a fuel cell as described above in that said electrode support is a cathode support.

In contrast to what is generally assumed, it is readily possible to use a cathode support made of a metallic material such as stainless steel or a chromium alloy. After all, in many applications the medium that is present on the cathode side is air and such metallic alloys have been designed precisely for use in such an air atmosphere. In principle, air will be present in excess in a fuel cell, so that the distribution of the gas that has to move through the porous cathode support is not critical, in contrast to the distribution of the gas on the anode side. As a result of the use of a cathode support, the anode is joined only to the electrolyte. This has the advantage that the anode can be further developed without restrictions in terms of adhesion/reactivity with the metal substrate. The anode can be made of any material known in the art, preferably nickel oxide, which during operation is converted into porous nickel mixed with an oxygen-conducting oxide. For the cathode that is applied to the cathode support it is likewise possible to use any material known in the state of the art, such as LSM (La₁₋ₓSrₓMnO₃).

The mechanical properties of the cell improve appreciably as a result of the use of the metallic support described above. This applies in particular when the cell is built in. Consequently, mobile applications are possible.

Such a cathode support can be obtained in any way known in the art. However, this is preferably produced in such a way that the final cathode support is finely porous. On the one hand, this does not impede gas transport and, on the other hand, this provides an adequate surface area for conduction. Such a fine, porous structure can be obtained by producing the cathode support by sintering a powder. The thickness of the cathode support can vary depending on the requirements. On the one hand, some flexibility is required but, on the other hand, this must not be too great because the ceramic material subsequently applied thereto is brittle. Therefore, preference is given to the thickness of the cathode support being between 100 μm and 3 mm.

The electrolyte preferably has a small thickness, such as 5 μm or less, as a result of which the fuel cell is able to operate at lower temperature.

The fuel cell described above can be produced in any way known in the art. An inexpensive production method comprises applying the cathode to the cathode support using a printing technique such as screen printing. The electrolyte can then be applied in any manner known in the art. Preferably, spin coating is used for this.

Yttria-stabilised zirconia is preferably used for the electrolyte, but other alternatives known in the art are also possible. Preferably, sinter-active particles are added to the electrolyte in order to restrict the sintering temperature as much as possible, in particular to 1000-1200° C. By using small (<30 nm) and thus sinter-active particles it is possible to ensure that the electrolyte is gastight after sintering. Tightness can also be obtained with a sintering aid.

The anode layer is then applied and the abovementioned sintering takes place. A current collector and gas distribution device can optionally be applied to the combination thus obtained, on both the anode and the cathode side.

As a result of the presence of a cathode support, the anode support can be dispensed with. As a result the anode can be provided with an optimum supply of anode gas.

The cathode support can have a thickness of a few millimetres, such as 2.5 mm, and consist of a stainless steel material or a chromium-based alloy such as (Cr5Fe1 (Y₂O₃)). The latter alloy can be obtained from the Plansee Company in Austria. The cathode support must be porous for the supply of gases and preferably electrically conducting. This porous support can, for example, be obtained by pressing or sintering suitable powders. Other materials that can be used for the cathode support comprise iron-chromium alloys to which aluminium can optionally be added. An iron-chromium alloy containing 15-30% chromium and optionally up to 15% aluminium added thereto may be mentioned as an example.

Further examples are AISI 430 and 441 steel. In the case of the addition of aluminium, it is possible, for example, to use “Ducralloy”. If the sintering technique described above is used, the starting powder preferably has a grain size of less than 150 μm. With this sintering technique the power can be brought into suspension and cast onto a plate or the like and optionally skimmed, after which surplus moisture is removed in some way or other. The green product can then be sintered. This method for the production of the green product is also known as tape casting.

Basicly, the abovementioned cell can be produced using simple means and leaves a particularly large degree of freedom as far as the choice of materials and structure of the anode are concerned, because the anode does not have to be coupled to any support.

The invention will be explained in more detail below with reference to an illustrative embodiment shown in the drawing. In the drawing a fuel cell indicated in its entirety by 1 is shown in the single FIGURE.

2 indicates the anode and 3 the electrolyte. The cathode is shown by 4. The whole is supported by cathode support 5. Inputs/outputs for gas and/or electricity are not shown.

Although the invention has been described above with reference to a preferred embodiment, it will be understood by those skilled in the art that many variants are possible that fall within the scope of the appended claims.

For instance, thicknesses deviating from the above can be chosen for the various layers and the composition and the method of application can likewise vary within the scope of the appended claims.

1-16. (canceled)

17. Fuel cell supported on the electrode side, comprising an anode, electrolyte and cathode, the electrode support comprising a porous part made of an alloy with iron and chromium, said electrode support being a cathode support and said cathode, electrolyte and anode are successively applied thereon and the combination obtained is sintered.

18. Fuel cell according to claim 17, wherein said cathode support comprises a sintered powder.

19. Fuel cell according to claim 17, wherein the electrolyte has a thickness of less than 10 μm.

20. Fuel cell according claim 17, wherein the anode comprises nickel/nickel oxide.

21. Fuel cell according to claim 17, wherein the cathode comprises LSM material.

22. Fuel cell according to claim 17, wherein said cathode support comprises Fe—Cr or Fe—Cr—Al material.

23. Fuel cell according to claim 17, equipped to be provided with air on the cathode side.

24. Fuel cell according to claim 17, wherein the anode has a thickness of less than 50 μm.

25. Method for the production of a metal-supported fuel cell, comprising the provision of a metallic support comprising at least iron or chromium, the successive application thereon of an electrode, electrolyte and other electrodes, a cathode being applied to said metallic support and the combination obtained is sintered at a temperature between 2000 and 1200° C.

26. Method according to claim 25, wherein said cathode support is obtained by sintering a powder.

27. Method according to claim 26, wherein said powder is cast in the form of a suspension and then sintered.

28. Method according to claim 25, wherein said application of said cathode comprises a printing technique.

29. Method according to claim 25, wherein the application of the electrolyte to said cathode comprises spin coating.

30. Method according claim 25, wherein said anode comprises nickel/nickel oxide.

31. Method according to claim 25, wherein said cathode support comprises stainless steel.

32. Method according to claim 26, wherein said powder has a particle size of less than 150 μm.
